(19) United States
(12) Patent Application Publication
(10) Pub. No.: US 2006/0181763 A1
(43) Pub. Date: Aug. 17, 2006

(54) Dispaly and a method of displaying and storing images

(76) Inventors: Siebe Tjerk De Zwart, Eindhoven (NL); Guofu Zhou, Eindhoven (NL); Eliav Itzhak Haskal, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,052

(22) PCT Filed: Mar. 31, 2004
(86) PCT No.: PCT/IB04/50370

§ 371 Date: Oct. 4, 2005

(30) Foreign Application Priority Data
Apr. 8, 2003 (EP) 03100941.8

(51) Int. Cl. G02B 26/00

(52) U.S. Cl. 359/296

(57) ABSTRACT

A display for displaying and storing images comprises an optically addressable electrophoretic display (PD) with a stack of a photoconductive layer (PCF) and an electrophoretic layer (EF) being sandwiched between electrodes (E1, E2). An optical addressing means (AD) supplies addressing light (AL) to the photoconductive layer (PCF). A controller (CO) controls a driver (DR1) to supply a drive voltage (DV) between the electrodes (E1, E2) with a value enabling a change of the optical state of the electrophoretic layer (EF) in response to the addressing light (AL) impinging on the photoconductive layer (PCF). Finally, the power consumption of the optical addressing means (AD) is minimized.

The invention relates to a display and a method of displaying and storing images.

Many types of displays exist which are able to present an image that has to change in time.

Displays which have to display video information, such as, for example, cathode ray tubes, plasma panels, and matrix displays need to update the image frequently due to the frame rate of the video information. These displays consume a lot of power.

Other displays on which the information has to change only with relatively large time intervals, such as for example electrophoretic type displays have an intrinsic memory behavior and are able to hold the image for a relatively long time while consuming a small amount of power. This is particularly true if such displays are passively addressed. However, it is not easy to passively address electrophoretic displays to change the image displayed.

It is an object of the invention to provide a display which is able to easily change the image displayed while it is able to keep the image displayed unchanged for a relatively long time without consuming a lot of power.

A first aspect of the invention provides a display as defined in claim 1. A second aspect of the invention provides a method of displaying as defined in claim 11. Advantageous embodiments are defined in the dependent claims.

The display comprises an optically addressable electrophoretic display with a stack of a photoconductive layer and an electrophoretic layer, which is sandwiched between electrodes. The photoconductive layer is optically addressed by addressing light. A controller controls a driver to supply a drive voltage between the electrodes with a value enabling a change of the optical state of the electrophoretic layer in response to the addressing light impinging on the photoconductive layer. Then, the controller controls the driver to change the drive voltage to a value enabling storage of the optical state of the electrophoretic layer independent on the amount of addressing light impinging upon the photoconductive layer. Finally, the controller controls the optical addressing to minimize a power consumption of the optical addressing.

The optical addressing may be performed by a laser or another display displaying an image, which collectively are further also referred to as addressing display.

The publication “A novel photo-addressable electronic paper using organic photoconductor utilizing hydroxyl gallium phtalocynine as charge generation material” of H. Kobayashy et. al. in Asia Display/IDW'01 page 1731 and 1732 discloses a photo-addressable electronic paper medium (further referred to as E-paper) which consists of microencapsulated cholesteric liquid crystal (further referred to as MCLC) and an organic photoconductor (further referred to as OPC) with a high photosensitivity. This display comprises an MCLC layer and an OPC layer which are sandwiched between electrodes. The OPC layer is addressed with a separate image appliance. The image appliance is disclosed to be a contact mask and a uniform light source. Where light impinges on the OPC layer, the impedance of the OPC cells decreases. The voltage across the MCLC cells increases and the optical state of the MCLC cells changes.

This publication does disclose that it is possible to change the displayed image by projecting an image on the OPC layer. It is however not disclosed how to control the combination of the E-paper display and the image appliance to obtain a display which is able to change the image displayed by the E-paper display in an easy way and which is able to hold this image for a relatively long time while the power consumption is relatively low.

In an embodiment in accordance with the invention as claimed in claim 2, the addressing display and the optically addressable electrophoretic display form a single unit. The electrophoretic display may be a E-paper display. Such a single unit (further also referred to as the combined display) is especially convenient in applications wherein the combined display has to display an image which has to change with relatively low rate, such as for example in a handheld E-book. The battery life of such applications is an extremely important issue in the market. Only when a new page of the book is required, the addressing means which preferably is a matrix display is made active for a short period in time to generate the new image. The electrophoretic part of the combined display is activated and the image projected on the photoconductor layer will cause the electrophoretic layer to take over the image generated by the matrix display. Then both the matrix display part of the combined display and the electrophoretic part of the combined display can be switched off or otherwise be brought into a state in which the power consumption is very low. Now the image is kept by the electrophoretic layer and the user is able to see the image (for example, to read the text) during a sufficiently long time period. This time period may even lasts hours or days without drawing a substantial power from the battery.

In an embodiment in accordance with the invention as claimed in claim 4, the matrix display is a poly-led display. Preferably, the well-known poly-led display with a transmissive anode and poly-led is changed such that the cathode is made transmissive. Such a poly-led display consumes a significant power in standby mode. The passive optically addressed electrophretic display is mounted behind the poly-led display to retain the image of the poly-led matrix display after the poly-led display has been switched off. The poly-led matrix display is used to address the passive optically addressed electrophoretic display. Every time the information on the passive optically addressed electrophoretic display must be updated, the poly-led matrix display flashes a new image into the passive display.

In an embodiment in accordance with the invention as claimed in claim 5, the addressing display is substantially completely switched off after the image has been transferred to the optically addressed electrophoretic display. The power consumed by the addressing display thus becomes minimal.

In an embodiment in accordance with the invention as claimed in claim 6, the driver which supplies the voltage across the optically addressed electrophoretic display is substantially completely switched off to minimize the power consumption of the display.

In an embodiment in accordance with the invention as claimed in claim 8, the microcapsules have a predetermined conductivity. In an embodiment in accordance with the invention as claimed in claim 9, the binder in-between the microcapsules has a predetermined conductivity. Such micro-capsules are known from E-ink displays which are a special kind of electrophoretic display in which electrophoretic particles are or an electrophoretic fluid is present within the micro-capsules.

The use of conductive microcapsules and/or binder has two advantages. First, due to the voltage division across the resistance of the photoconductor layer and the electrophoretic layer, it is possible to keep the voltage across the cells/capsules of said layer low enough such that at dim surround light the optical state will not change, while the voltage is large enough to change the optical state when the addressing light impinges. Secondly, after removing the voltage across the series arrangement of the photoconductive layer and the electrophoretic layer the voltage across the electrophoretic layer is not kept by its capacitance and thus the voltage across said layer is removed to stop a further movement of the particles in the said layer.

These and other aspects of the invention are apparent from and will be elucidated with reference to the embodiments described hereinafter.

In the drawings:

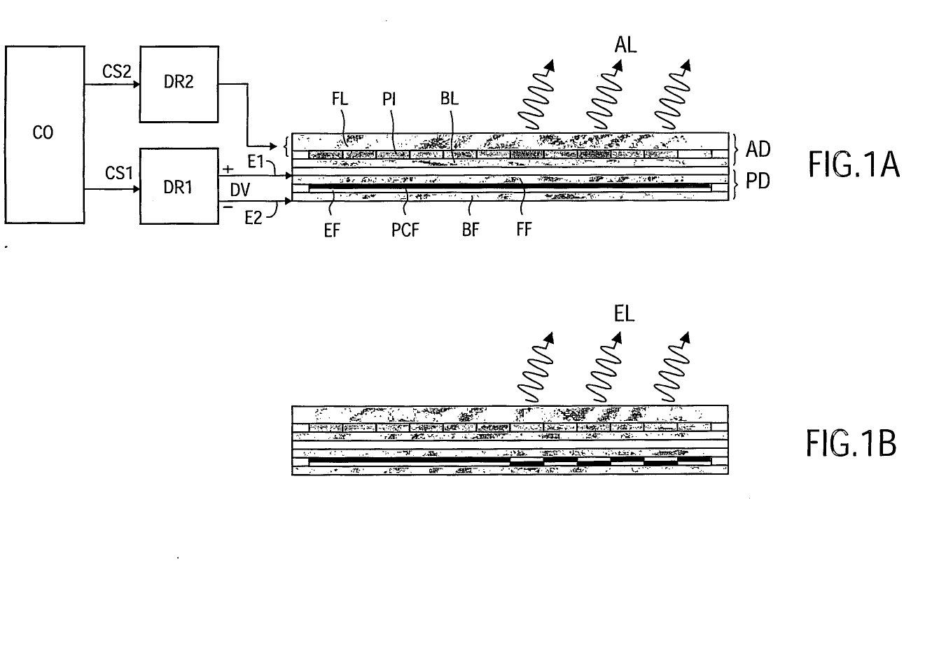

FIG. 1 shows a combination of a matrix display and an optically addressable electrophoretic display,

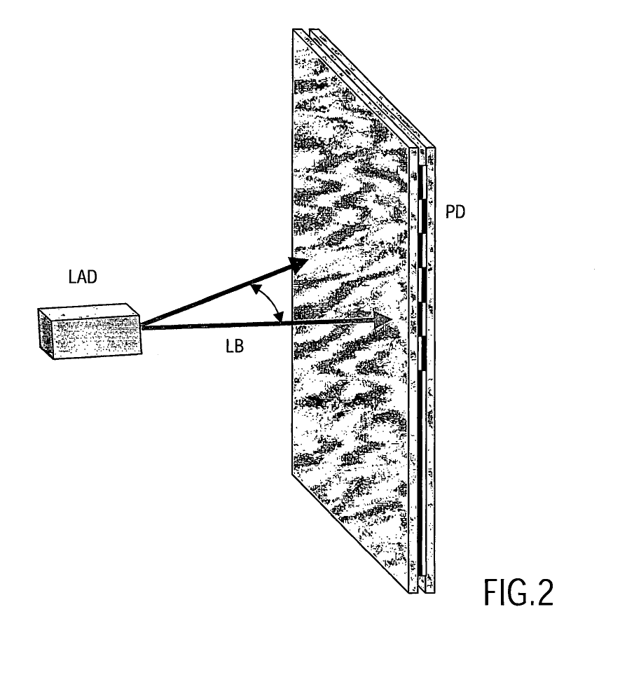

FIG. 2 shows a combination of a laser scanner and an optically addressable electrophoretic display, and

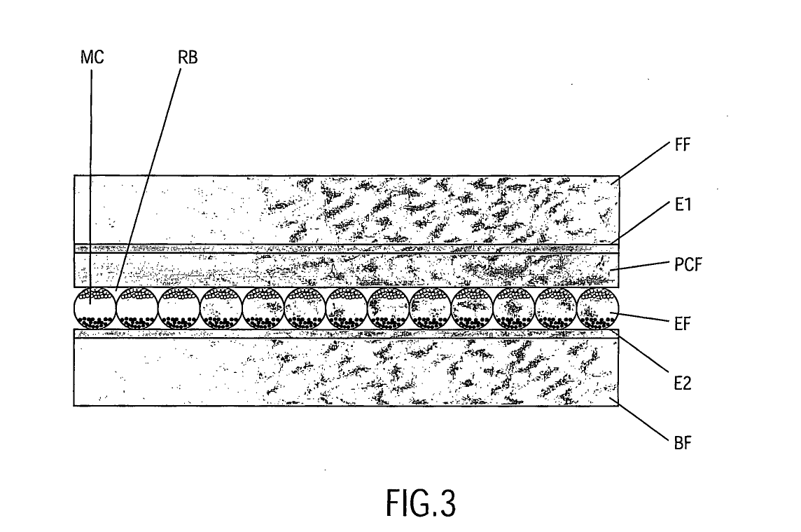

FIG. 3 shows an embodiment of an optically addressable electrophoretic display in more detail.

FIG. 1 shows a combination of a matrix display and an optically addressable electrophoretic display. FIG. 1A shows the combined display in the active state wherein the matrix display AD generates an image. FIG. 1B shows the combined display in the stand-by or storage state wherein the image is stored in the optically addressable electrophoretic display PD and the matrix display AD is inactive. The optically addressable electrophoretic display PD comprises a front electrode E1, a photoconductive layer or foil PCF, an electrophoretic (for example, e-ink) layer EF and a back electrode E2. The matrix display (or more general the optical addressing means) AD may be any matrix display which generates light AL. The matrix display comprises pixels PI sandwiched between a transparent front layer FL and a back layer BL. The matrix display AD is optically coupled through the back layer BL, which should be (partially) transparent, to the photoconductive layer PCF to supply addressing light AL to the photoconductive layer PCF. In FIG. 1, the matrix display supplies the light AL both to a viewer as indicated by the arrows and to the photoconductive layer PCF. The operation of the combined display is elucidated in the now following.

A controller CO generates control signals CS1 and CS2. The control signals CS1 are used to control a driver DR1 which supplies a drive voltage DV between the electrodes E1 and E2 of the optically addressable electrophoretic display EF. The control signals CS2 are used to control a driver DR2 which drives the matrix display AD.

The driver DR1 supplies a drive voltage DV between the electrodes E1, E2 with a value which enables a change of the optical state of the electrophoretic layer EF in response to an amount of the addressing light AL impinging on the photoconductive layer PCF. The image composed by the pixels PI of the matrix display AD which is transferred to photoconductive layer PCF will change the optical state of the electrophoretic layer EF such that it is in accordance with the image. Then, the driver DR1 changes the drive voltage DV to a value enabling a storage of the optical state of the electrophoretic layer EF independent on the amount of addressing light AL impinging on the photoconductive layer PCF. Thus, the image on the matrix display AD is stored in the electrophoretic display PD. Finally, the power consumption of the matrix display AD is minimized.

The combined display is able to store an image for a long time in the optically addressable electrophoretic display PD, while the power consuming matrix display AD is (substantially) inactive. When the image should be changed, the matrix display AD is brought into the active state for a short period in time only to transfer a new image to the electrophoretic display PD. Thus, the information in the electrophoretic display PD can easily be changed while the power consumption is minimal.

In FIG. 1A, the viewable light AL is generated by the matrix display AD. In FIG. 1B, the viewable light EL is generated by the electrophoretic display EL, the matrix display AD is in a transmissive mode. It is possible to interchange the position of the matrix display AD and the electrophoretic display PD. When the matrix display AD is active, its light passes the electrophoretic display to reach the viewer. In the inactive state of the matrix display AD, its optical state is not relevant as the image stored in the electrophoretic display PD is visible directly by the viewer.

It is also possible to exchange the position of the electrophoretic layer EF and the photo conductive layer PCF.

FIG. 2 shows a combination of a laser scanner and an optically addressable electrophoretic display. Now, the electrophoretic display PD is addressed by a laser scanner LAD. The laser scanner LAD scans a laser beam LB along the optically addressable electrophoretic display PD. The intensity of the laser beam LB is controlled in accordance with the image to be written on the photoconductive layer PCF. The operation of the laser addressed electrophoretic display PD is similar to the operation of the optically addressed electrophoretic display PD which is addressed by the matrix display AD. First the electrophoretic display PD is brought in a state wherein the local conductivity of the photoconductive layer PCF determines the optical state of the electrophoretic layer EF. Then, the laser scanner LAD is activated to scan the laser along the electrophoretic display PD to transfer the image to the photoconductive layer PCF. Now, the electrophoretic display PD is brought in a state wherein the optical state of the electrophoretic layer EF is stored independent on the local conductivity of the photoconductive layer PCF. Finally, the laser scanner LAD is inactivated to minimize its power consumption. Again, the laser scanner LAD only needs to be active during a short period in time required to store the image in the electrophoretic display PD.

FIG. 3 shows an embodiment of an optically addressable electrophoretic display in more detail. The optically addressable electrophoretic display comprises a stack of the next consecutive layers: a back foil BF, a back electrode E2, the electrophoretic layer EF, the photoconductive foil PCF, the front electrode E1, and the front foil FF. The electrophoretic layer EF comprises microcapsules MC and a binder RB in-between the microcapsules MC. The microcapsules MC are filled with colored particles. In the display shown, each microcapsule MC comprises white and black particles which are oppositely charged. The particles are moved in the microcapsules MC by supplying a voltage and thus an electric field across the microcapsules MC. The voltage supplied between the front electrode E1 and the back electrode E2 occurs across the series arrangement of the photoconductive foil PCF and the e-ink layer EF. If light impinges at a particular location on the photoconductive foil PCF, the conductivity of the photoconductive foil PCF increases. At this particular location, a major part of the voltage supplied between the electrodes E1 and E2 will be present across the electrophoretic layer EF and the optical state of the microcapsule(s) at this location will be determined by this voltage.

As both the photoconductive foil PCF and the electrophoretic layer have a capacitance, the voltage applied to the electrodes E1 and E2 will be capacitively tapped during the level changes. Therefore, when the display is activated, this voltage has to be increased sufficiently slowly, such that the voltage across the electrophoretic layer stays low enough. If the voltage rises to steep, due to the capacitive division, the voltage across the electrophoretic layer may become too large and influence its behavior. After the voltage has been applied sufficiently slowly, the writing of the data with the addressing light can start. After the writing operation, the voltage should slowly decrease, again to prevent undesired voltages across the electrophoretic layer which may influence the optical behavior of the electrophoretic layer.

It is possible to use this capacitive division to erase the display. If a sufficiently high voltage is applied sufficiently fast, the electrophoretic layer will change into one of its optical limit situations: for example, it will become completely black or white if black and white particles are used.

Further, the capacitance of the e-ink layer EF has the drawback that a voltage across the electrophoretic layer EF will leak away only slowly. Thus after removing the voltage across the electrodes E1 and E2, still a voltage will be present across the microcapsules MC causing the optical state of the microcapsule to change.

Both drawbacks can be alleviated by giving the microcapsules MC and/or the binder RB a predetermined conductivity. The predetermined resistance of the electrophoretic layer EF can be selected to lower the influence of the capacitive division, and this predetermined resistance increases the drop of the voltage across the electrophoretic layer EF.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display for displaying and storing images, and comprising:
an optically addressable electrophoretic display (PD) with a stack of a photoconductive layer (PCF) and an electrophoretic layer (EF) being sandwiched between electrodes (E1, E2),
an optical addressing means (AD; LA) being optically coupled to the photoconductive layer (PCF) for supplying addressing light (AL),
a driver (DR1) for supplying a drive voltage (DV) between the electrodes (E1, E2),
a controller (CO) for controlling:
the driver (DR1) to supply the drive voltage (DV) with a value enabling a change of the optical state of the electrophoretic layer (EF) in response to an amount of the addressing light (AL) impinging on the photoconductive layer (PCF),
the driver (DR1) to change the drive voltage (DV) to a value enabling a storage of the optical state of the electrophoretic layer (EF) independent on the amount of addressing light (AL) impinging on the photoconductive layer (PCF), and
the optical addressing means (AD) to minimize a power consumption of the optical addressing means (AD) and/or the electrophoretic display.

2. A display as claimed in claim 1, wherein the optical addressing means (AD) is attached to the optically addressable electrophoretic display (PD) to form a single unit.

3. A display as claimed in claim 1, wherein the optical addressing means (AD) is a matrix display (AD) with pixels, the pixels generating the addressing light (AL) impinging on corresponding cells of the photoconductive layer (PCF).

4. A display as claimed in claim 3, wherein the matrix display (AD) is a poly-led display.

5. A display as claimed in claim 1, wherein the controller (CO) is arranged for minimizing a power consumption of the optical addressing means (AD) by switching off the optical addressing means (AD).

6. A display as claimed in claim 1, wherein the driver (DR1) is switched off after the drive voltage (DV) has been changed to a value enabling storage of the optical state of the electrophoretic layer (EL).

7. A display as claimed in claim 1, wherein the electrophoretic layer (EF) comprises microcapsules (MC).

8. A display as claimed in claim 7, wherein the microcapsules (MC) have a predetermined conductivity.

9. A display as claimed in claim 7, wherein the electrophoretic layer (EF) comprises a binder (RB) in-between the microcapsules (MC), the binder (RB) having a predetermined conductivity.

10. A display as claimed in claim 8, wherein the predetermined conductivity is selected to keep the voltage across the electrophoretic layer (EF) low enough at dim surround light to prevent its optical state to change, while the voltage across the electrophoretic layer (EF) is large enough to change the optical state when the addressing light (AL) impinges.

11. A method of displaying on an optically addressable electrophoretic display with a stack of a photoconductive layer (PCF) and an electrophoretic layer (EF), the stack being sandwiched between electrodes (E1, E2), and an optical addressing means (AD; LA) being optically coupled to the photoconductive layer (PCF) for supplying addressing light (AL), the method comprising successively:
supplying (AD, LA) a drive voltage (DV) between the electrodes (El, E2) with a value enabling a change of the optical state of the electrophoretic layer (EF) in response to an amount of the addressing light (AL) impinging on the photoconductive layer (PCF),
supplying (AD, LA) the drive voltage (DV) with a value enabling a storage of the optical state of the electrophoretic layer (EF), and
controlling (CO) the addressing means (AD) to minimize a power consumption of the addressing means (AD) and/or the electrophoretic display.
